(19) United States
(12) Patent Application Publication
(10) Pub. No.: US 2008/0211222 A1
(43) Pub. Date: Sep. 4, 2008

(54) BOOK

(76) Inventor: Michael L. Nakamura, Crystal Lake, IL (US)

Correspondence Address: Pauley Petersen & Erickson, Suite 365, 2800 W. Higgins Road, Hoffman Estates, IL, 60169, US

(21) Appl. No.: 12/120,703

(22) Filed: May 15, 2008

Related U.S. Application Data
(63) Continuation-in-part of application No. 11/542,614, filed on Oct. 2, 2006.

(51) Int. Cl. B42D 3/00; B42D 1/00

(52) U.S. Cl. 281/31; 281/29; 281/39; 281/38

(57) ABSTRACT

A book with markable pages constructed of washable material and removably disposed between two pillow-like covers, namely, a first pillow and a second pillow. The first pillow includes a first edge and a first periphery and the second pillow includes a second edge and a second periphery. The second edge is hingedly connected to the first edge. The book further includes a fastener positioned along and between the first periphery and the second periphery. The book is closeable and lockable. One or more of the markable pages defines a pocket for accepting a support sheet. The book further includes, disposed between the first pillow and the second pillow, one or more display pages each having a plurality of display pockets, and one or more pouch pages each defining an openably closeable storage pouch.

### CROSS REFERENCE TO RELATED APPLICATION

This patent application is a continuation-in-part patent application of U.S. patent application Ser. No. 11/542,614, filed on 2 Oct. 2006, which is the co-pending parent application and which is incorporated by reference herein and is made a part hereof, including but not limited to those portions which specifically appear in this patent application.

### BACKGROUND OF THE INVENTION

1. Field of the Invention

This invention relates generally to a book, and, more particularly, to a lockable book having a plurality of markable pages constructed of a washable material disposed between two pillow-like book covers.

2. Description of Related Art

Story books, coloring books and diaries are popular among children, tweens and teenagers. Conventional story books, coloring books and diaries are usually constructed of paper products. Coloring books and diaries which are made of paper products are not suitable for multiple uses and are usually discarded after a single use.

There is a need or a desire for a story book, a coloring book and/or a diary suitable for multiple uses and for multi-purpose uses, including coloring, writing, storing personal items and media-playing.

### SUMMARY OF THE INVENTION

According to a preferred embodiment of this invention, a book includes a first pillow having a first edge and a first periphery and a second pillow having a second edge and a second periphery. The second edge is hingedly connected to the first edge. A fastener, such as a zipper, is preferably positioned along and between the first periphery and the second periphery for releaseably fastening the first periphery and the second periphery. The book may further include a lock or similar device for locking the book in a closed position.

The book may also include a plurality of markable pages disposed between the first pillow and the second pillow. The markable pages are preferably made of a washable material such that the markable pages can be washed or cleaned following coloration to remove color markings therefrom. Each page preferably forms a page pocket. A support sheet, such as an EVA foam sheet, is preferably positioned in the page pocket. The markable pages, individually or as a unit, may be reattachably removable from the book. The book may further include one or more page fasteners for attaching the plurality of markable pages to the book.

The book may further include at least one pouch page disposed between the first pillow and the second pillow. The pouch page defines an openably closeable storage pouch, which can be used for storing various personal items.

The book may further include at least one display page having one or more display pockets, which can be used to insert and display items such as pictures, photographs, postcards, stamps, stickers or other items.

According to one embodiment, the book may further include one or more auditory transducers disposed within the first pillow and/or the second pillow. The auditory transducer, for example a speaker, is operably connectable to a player device, such as an MP3 player.

The book may further include one or more storage pockets formed within or with respect to the first pillow and/or the second pillow. Storage pockets are preferably designed to store secondary elements such as markers, pens, pencils, crayons, books, notebooks, diaries, notepads, personal players, or other items.

### BRIEF DESCRIPTION OF THE DRAWINGS

The drawings show a book, according to preferred embodiments of this invention, wherein:

FIG. 1 is a front perspective view of a book, in a closed position, according to one embodiment of this invention;

FIG. 2 is a front perspective view of the book of FIG. 1, in an open position;

FIG. 3 is a front perspective view of a book, in an open position, according to an embodiment of this invention;

FIG. 4 is a front perspective view of the book of FIG. 1, in an open position, showing a display page;

FIG. 5 is a front perspective view of the book of FIG. 1, in an open position, showing a display page and a pouch page;

FIG. 6 is a front perspective view of the book of FIG. 1, in an open position, showing a pouch page and storage pockets formed with respect to a second pillow of the book.

It should be understood that the drawings are of preferred embodiments, and that there may be other embodiments of this invention. Therefore, it should be understood that the drawings are not intended to limit the scope of this invention, but that the scope of this invention be defined by the claims that follow the description of preferred embodiments.

### DETAILED DESCRIPTION OF THE INVENTION

The present invention provides a book. The book preferably includes two pillows, namely, a first pillow and a second pillow, which form the front and back covers of the book, respectively. As used herein, the term “pillow” is defined as a three-dimensional object constructed of soft and flexible materials. The book includes a plurality of markable pages constructed of a washable material, such as a fabric material, and disposed between the two pillows. The markable pages and/or the pillows may be printed on either side with text and/or graphics. The markable pages are preferably bound together along an interior edge portion of each markable page and are preferably removably attachable to the book between the first pillow and the second pillow. The markable pages may be removable as a unit or each page may be independently removable from the book. The book further includes at least one display page having a plurality of display pockets for displaying one or more objects, for example, pictures, photographs, postage stamps, postcards, stickers and combinations thereof. The book further includes at least one pouch page disposed between the first pillow and the second pillow and defining an openably closeable storage pouch. The book may further include an auditory transducer, such as a speaker, connectable to a player device.

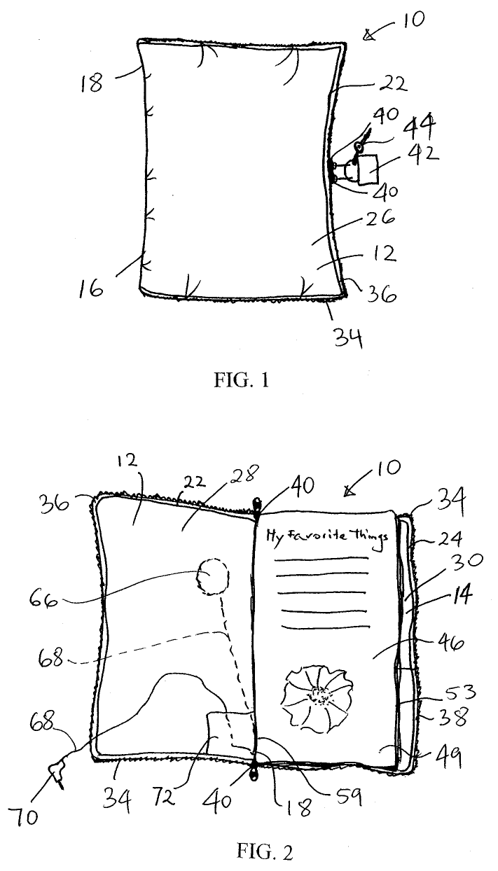

Exemplary embodiments of book 10 are shown in FIGS. 1-6. FIG. 1 shows book 10 in a closed position, while FIGS. 2-6 show book 10 in various open positions.

Generally with reference to FIGS. 1-6, book 10 includes first pillow 12 and second pillow 14. First pillow 12 is the front cover of book 10 and can optionally be printed with text and/or graphics on either side thereof. Second pillow 14 is the back cover of book 10 and can optionally be printed with text and/or graphics on either side thereof. First pillow 12 has first edge 16 disposed at or toward seam 18 of book 10. Second pillow 14 has second edge 20 also disposed at or toward seam 18 of book 10. Second edge 20 is hingedly connected to first edge 16 at or around seam 18.

First pillow 12 has first periphery 22 extending between and connecting opposing ends of first edge 16. Similarly, second pillow 14 has second periphery 24 extending between and connecting opposing ends of second edge 20. According to one embodiment of this invention, shown in FIG. 1, first edge 16 and first periphery 22 form a generally rectangular shape. Similarly, second edge 20 and second periphery 24 form a generally rectangular shape. The shape of first pillow 12 may correspond to the shape of second pillow 14. It should be understood that although the drawings show a book of this invention having a generally rectangular shape, the book of this invention can have any other desirable shape and/or size.

First pillow 12 includes front sheet 26 and inner front sheet 28, opposite front sheet 26. Front sheet 26 is preferably connected to inner front sheet 28 along first periphery 22 and first edge 16 of first pillow 12 such that a first cavity (not shown) is formed between front sheet 26 and inner front sheet 28. Likewise, second pillow 14 includes back sheet 32 and inner back sheet 30, opposite back sheet 32. Back sheet 32 is preferably connected to inner back sheet 30 along second periphery 24 and second edge 20 of second pillow 14 such that a second cavity (not shown) is formed between inner back sheet 30 and back sheet 32. Second edge 20 of second pillow 14 is hingedly connected to first edge 16 of first pillow 12.

According to one embodiment of this invention, front sheet 26 and back sheet 32 are made from a single sheet of material. Similarly, inner front sheet 28 and inner back sheet 30 may be made of a single sheet of material.

Book 10 preferably further includes a first filler (now shown) positioned in the first cavity formed between front sheet 26 and inner front sheet 28, and a second filler (not shown) positioned in the second cavity formed between inner back sheet 30 and back sheet 32. The first filler and/or the second filler is preferably a natural or synthetic stuffing material, for example, cotton, wool, polyester and/or any suitable stuffing material known to those skilled in the art.

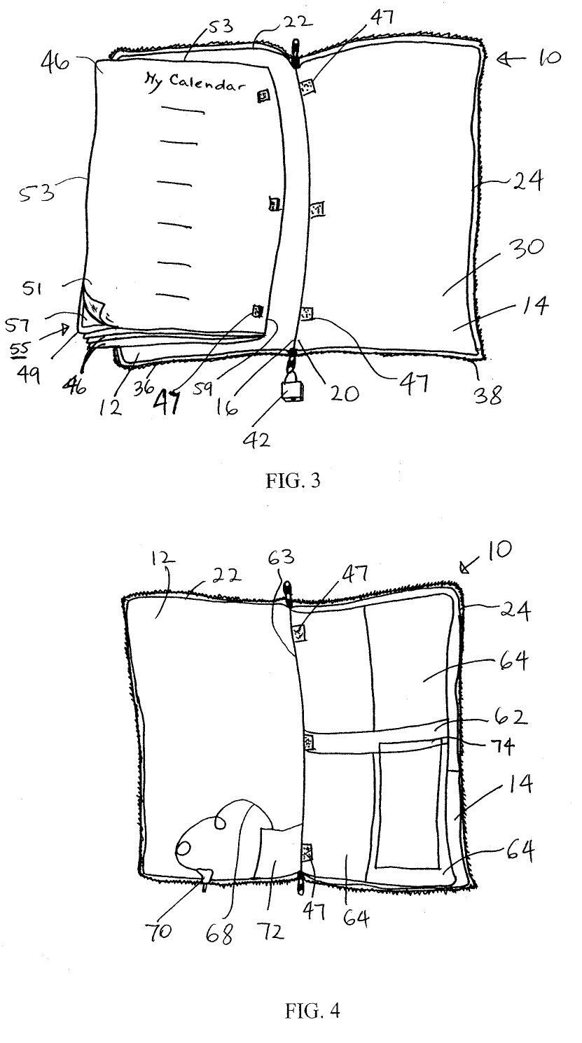

As shown in FIGS. 1-6, book 10 further includes fastener 34 for fastening first pillow 12 to second pillow 14 along first periphery 22 and second periphery 24 to hold book 10 in a closed position, as shown in FIG. 1. Fastener 34 is preferably adapted to secure first periphery 22 to second periphery 24 to hold book 10 in a closed position. In one embodiment of this invention, as shown in FIG. 3, fastener 34 comprises a zipper extending along and between first periphery 22 and second periphery 24. Fastener 34 preferably includes first fastener portion 36 connected along first periphery 22, second fastener portion 38 connected along second periphery 24, and at least one sliding element 40. Sliding element 40 is slidable along first fastener portion 36 and corresponding second fastener portion 38 in a first direction and in a second direction, opposite the first direction. Preferably, when sliding element 40 is moved, for example by pulling or pushing, in the first direction, it engages first fastener portion 36 with second fastener portion 38 to close fastener 34. Preferably, when sliding element 40 is moved, for example by pulling or pushing, in the second direction, it disengages first fastener portion 36 from second fastener portion 38 to open book 10 by releasing first periphery 22 from second periphery 24. According to one embodiment of this invention, book 10 of this invention includes one sliding element 40. According to another embodiment of this invention, book 10 of this invention includes two sliding elements 40, such as shown in FIG. 2.

Book 10 of this invention further includes at least one lock 42, as shown in FIG. 1. Lock 42 is preferably any mechanical or electromechanical lock known to those skilled in the art. For example, lock 42 may be a padlock, as shown in FIG. 1, operated by at least one key 44. As will be appreciated by those skilled in the art following the teachings herein provided, additionally or alternatively, the present invention may be used with any other suitable lock known to those skilled in the art, for example, a magnetic keyed lock, a key card lock, an electronic lock, a digital lock and/or a combination lock. In an embodiment of this invention in which book 10 includes one sliding element 40, lock 42 is preferably engageable with sliding element 40 and, directly or indirectly, with first pillow 12 and/or second pillow 14 of book 10 to lock book 10 in a closed position. Locking book 10 preferably prevents access by an unauthorized person. According to one embodiment of this invention, lock 42 is operated by turning key 44. Key 44 is preferably engageable with lock 42 to release the lock 42 and thus unlock first periphery 22 from second periphery 24. Additionally or alternatively, according to other embodiments of this invention, lock 42 may include a keypad enabling the user to enter a numeric, alphabetic and/or alphanumeric combination on the keypad to lock or open the lock 42. In yet another embodiment of this invention, lock 42 may include a key card for locking or unlocking the lock 42 by engaging the key card with the lock 42.

According to one embodiment of this invention, as shown in FIG. 2, book 10 includes two sliding elements 40, each having a loop. Lock 42 engages the two sliding elements 40, for example through the loops of the two sliding elements 40, to lock the two sliding elements 40 together, thereby locking the book when in a closed position, as shown in FIG. 1. Key 44 is engageable with lock 42 to release the lock 42 and thus the two sliding elements 40. Each of the sliding elements 40 is independently slidable along fastener 34 in a first direction to close fastener 34 and in a second direction to open fastener 34.

Book 10 preferably further includes a plurality of markable pages 46 disposed between first pillow 12 and second pillow 14. Markable pages 46 are preferably constructed of a washable material or a coated substrate. Text and/or graphics are preferably printed on one or both sides of at least one page of the plurality of markable pages 46.

For example, in one embodiment of this invention, one side of a page of the plurality of markable pages 46 may have the heading “My Favorite Things” printed at the top of the page, as shown in FIG. 2. A plurality of blank lines may be printed underneath the heading “My Favorite Things”, allowing for user input of his or her favorite people, activities, food, etc. Additionally, each line of the plurality of lines may start with its own heading, for example, “Food”, “Candy”, “Song”, “Celebrity”, “Music Group”, “Hobbies”, “Best Friend”, etc., allowing for a user to input user's preferences in relation to each category. Alternatively or additionally, one or more pages of the plurality of markable pages may include a plurality of pre-printed blank lines, allowing for user input thereon. One or more pages of the markable pages may further include background graphics, other graphics and/or text. For example, one or more pages of the plurality of markable pages may include a printed text, such as a story or information, and/or graphics, such as a photograph or a picture.

One or more pages of the plurality of markable pages are markable, such as by coloring and/or writing, with a coloring instrument, such as a pen, a pencil, a crayon or a marker. The pages are washable to remove the entries/colors entered by a user and can be reused for subsequent entries/colorations. The plurality of markable pages 46 are preferably detachable from the book as a unit and/or individually for more convenient removal of colors and/or markings therefrom.

Preferably, one or more pages of the plurality of markable pages 46 are constructed of a washable material. By “washable” material, it is understood any natural or man-made material capable of retaining colors placed thereon using pens, pencils, crayons, markers, or other coloring instruments, but which releases such colors when treated with water or other cleaning substances.

For example, in one embodiment of this invention, the plurality of markable pages 46 are made of a fabric material. Examples of fabrics useful in constructing the markable pages of the book of this invention include natural and synthetic fabrics, such as, without limitation, cotton, rayon, and polyester materials. Desirably, the portions of book 10 which include pre-printed designs, graphics and/or text are made from materials that are appropriate for printing.

After coloration with a pen, a pencil, a marker and/or a crayon, one or more markable pages are desirably washed in water, optionally containing a detergent and/or another cleaning substance, to remove colors from the markable pages without substantially affecting the quality of the fabric and/or individual pages. Desirably, markable pages 46 of book 10 can be placed in a regular home or commercial washing machine and washed to remove colors therefrom. After washing, markable pages 46 may be ironed to remove wrinkles, if any. Alternatively, markable pages 46 of this invention can be made of a wrinkle-free washable material. Following cleaning, markable pages 46, which are cleared of colors and/or markings during the cleaning process, may be colored or written on again. Thus, because markable pages 46 of book 10 of this invention are constructed of a washable material, following coloration, colors or color markings can be removed from markable pages 46, and markable pages 46 can be reused for another coloration and/or writing. This process can be repeated as many times as desired, and markable pages of this invention can be used for coloring and/or writing multiple times.

In another embodiment of the present invention, at least one of the plurality of markable pages comprises a composite material, for example, a coated substrate. Coating on the substrate is preferably smooth for easier coloring, writing and/or cleaning. Colors and markings can be removed from the pages comprised of a coated substrate by wiping the pages clean with a cloth, optionally containing a cleaning substance. Alternatively, markable pages 46 may be washed in a washing machine, as described above. As will be appreciated, various and alternative washable materials available in the art can be used for the markable pages of the book of this invention.

In one embodiment of this invention, as shown in FIG. 3, each page of the plurality of markable pages 46 includes two page surfaces, namely, first page surface 49 and second page surface 51, opposite first page surface 49. Preferably, first page surface 49 and second page surface 51 each comprises a sheet of fabric. Markable page 46 is assembled by connecting the two sheets of fabric to each other along markable page periphery 53. When the two sheets of fabric are attached along markable page periphery 53, for example by stitching, markable page 46 preferably forms page pocket 55 between the two sheets of fabric forming first page surface 49 and second page surface 51. As the markable pages 46 are preferably made of flexible fabric sheets, according to one embodiment of this invention, book 10 further includes support sheet 57 positioned within page pocket 55. A support sheet is preferably used to stiffen the individual markable page, but allows the individual markable page to still remain flexible and soft. Support sheet 57 is preferably made of stiffer material than the material used to construct markable page 46, and may be made of, for example, EVA foam or other suitable material. Alternatively, or additionally, support sheet 57 may be made of a nonwoven material, such as a plastic fiber sheet, film, or grid material or any other suitable material known to those skilled in the art.

Each page of the plurality of markable pages 46 includes interior edge portion 59 disposed at or around seam 18 of book 10. The pages of the plurality of markable pages 46 can be connected to each other along their respective interior edge portions 59.

The plurality of markable pages 46, individually or as a unit, may be made of a single folded sheet of fabric. Alternatively, each page can be made of two sheets of fabric as described above. Still alternatively, the plurality of markable pages may be assembled from a plurality of page units as disclosed in PCT International Application No. PCT/US2007/021106, filed 1 Oct. 2007, the disclosure of which is incorporated herein by reference.

Various and alternative fabrics or materials can be used to construct book 10, and more particularly the pillows, the markable pages, one or more display pages (described below) and/or one or more divider pages (described below). Examples of fabrics and materials useful in constructing the book of this invention include natural and synthetic fabrics or materials, such as, without limitation, cotton, rayon, polyester, plastic or other suitable materials known to those skilled in the art. Desirably, the portions of the book which are printed on, e.g., the markable pages and the pillow sheets, are made from materials that are appropriate for printing. The pillow sheets, markable pages and/or display pages can be formed from the same or different materials.

The plurality of markable pages 46 may be reattachably removable from book 10 individually or as a unit. According to one embodiment of this invention, book 10 includes one or more page fasteners 47. According to certain embodiments of this invention, as shown in FIGS. 3 and 4, book 10 includes a plurality of page fasteners 47 spaced along seam 18 of book 10. Page fasteners 47 are preferably, but not necessarily, hook and loop fasteners, wherein either the loop or the hook portion is connected along seam 18 of book 10, such as by sewing the fastener portion into seam 18 of book 10, and the other corresponding fastener portion is attached to one or more pages or the seam of the plurality of markable pages. The plurality of markable pages 46 are then removably fastenable to book 10 by joining the corresponding hook and loop page fasteners 47.

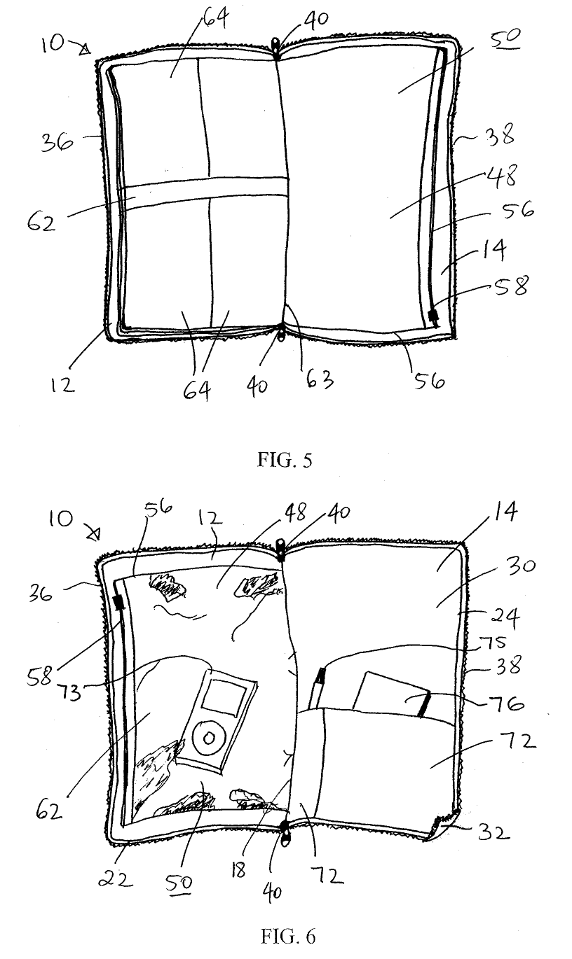

Book 10 further includes at least one pouch page 48, as shown in FIGS. 5 and 6. Pouch page 48 preferably defines a recloseable storage pouch 50. Storage pouch 50 is preferably closeable along at least a portion of pouch page periphery 56. In one embodiment of this invention, pouch page 48 is a resealable zipper storage bag sewn into seam 18 of book 10 along an edge of the storage bag opposite pouch zipper 58, as shown in FIG. 6. Pouch zipper 58 is preferably positioned along at least a portion of pouch page periphery 56, for example, along the edge opposite seam 18 of book 10, as shown in FIG. 6. Pouch page 48 is preferably, but not necessarily, made of a clear and/or a see-through material for easier identification and retrieval of objects placed within storage pouch 50. In one embodiment of this invention, as shown in FIG. 6, pouch zipper 58 is positioned along an edge opposite seam 18 of book 10, and the edge opposite pouch zipper 58 is sewn into seam 18 of book 10. Pouch page 48 may be used to store a variety of items, including, but not limited to, memorabilia, personal items, player devices, writing and/or coloring tools, collectibles, and/or other items that can be fit within storage pouch 50. FIG. 6 shows player device 73 stored in storage pouch 50.

Book 10 preferably further includes at least one display page 62, as shown in FIGS. 4 and 5. Display page 62 preferably includes at least one display pocket 64 formed with respect to one or both sides of display page 62. In one embodiment of this invention, display page 62 includes a plurality of display pockets 64 formed on both sides of display page 62. Display pockets 64 may be integrated with display page 62. Alternatively, display pockets 64 may be formed by attaching one or more separate sheets of material, for example one or more clear plastic sheets, to display page 62 by methods known to those skilled in the art. Each of the plurality of display pockets 64 is preferably adapted to receive and store at least one object selected from the group consisting of a photograph, a postage stamp, a sticker, a postcard, a picture, combinations thereof and/or other items. FIG. 4 shows display object 74 displayed in display pocket 64. The plurality of display pockets 64 can include display pockets 64 of the same or different shapes and/or sizes. Display page 62 is connected to book 10 along display page inner edge 63. According to one embodiment of this invention, display page 62 is sewn into seam 18 of book 10 along display page inner edge 63.

According to certain embodiments of this invention, as shown in FIGS. 2 and 4, book 10 may include an auditory transducer, for example speaker 66, operably connectable to a player device, for example an MP3 player or an IPOD® device. In one embodiment of this invention, as shown in FIG. 2, speaker 66 is disposed within first pillow 12. Speaker 66 is preferably connectable, for example through connection cable 68 and an audio connector, such as, for example, jack plug 70, to a player device. A portion of connection cable 68 may be positioned within first pillow 12 and a portion of connection cable 68 may be positioned outside first pillow 12, as shown in FIG. 2. Alternatively or additionally, the auditory transducer can be wirelessly connectable to a player device and/or can incorporate a player device. Other embodiments of this invention include an auditory transducer positioned within second pillow 14.

According to one embodiment of this invention, book 10 further includes one or more storage pockets 72 formed within or with respect to first pillow 12 and/or within or with respect to second pillow 14. For example, as shown in FIG. 2, book includes storage pocket 72 formed with respect to inner front sheet 28, which can be used to store jack plug 70 and at least a portion of connection cable 68 when speaker 66 is not connected to a player device. Additionally or alternatively, storage pocket 72, as shown in FIG. 2, may be designed to accommodate a player device such that the player device, for example an IPOD® device or an MP3 player, can be placed in storage pocket 72.

According to one embodiment of this invention, book 10 further includes one or more storage pockets 72 formed within or with respect to second pillow 14. In one embodiment of this invention, as shown in FIG. 6, book 10 includes a plurality of storage pockets 72 formed with respect to second pillow 14. Storage pockets 72 may be attached or formed with respect to inner back sheet 30, as shown in FIG. 6.

One or more storage pockets 72 may be designed to accommodate one or more secondary elements selected from the group including, but not limited to, a marker, a book, a notebook, a notepad, a pen, a pencil, a crayon, and combinations thereof. For example, in one embodiment of this invention, the book includes a marker and a diary, each positionable in separate storage pocket 72 formed with respect to inner back sheet 30. In another embodiment of this invention, shown in FIG. 6, book 10 includes marker 75 and conventional pocket book 76, each positionable in a separate storage pocket 72 formed with respect to inner back sheet 30.

According to one embodiment of this invention (not shown), the book of this invention further includes at least one divider page positionable between any of the markable pages, the display pages and/or the pouch pages described above. Divider pages may include tabs or other indicators that can be used to easily identify different sections of the book of this invention. One or more divider pages may be permanently sewn into the seam of the book or may be reattachably removable from the book.

As will be appreciated, various and alternative sizes, shapes, and/or configurations are available for the book, the pillows, the markable pages, support sheets, display pages, pouch pages, divider pages and seams of this invention. As shown in FIGS. 1-6, book 10 has an overall rectangular configuration, although other shapes, such as squares, ovals, circles, and triangles, are available as well. The book of this invention can be sized according to need. As shown in FIG. 1, seam 18 is disposed along a longer edge or side of the rectangular book 10. A seam of book 10 may be disposed along a shorter side of the rectangular book 10.

The book of this invention may be formed as a theme book featuring a cartoon character, a musician, a band, an actor, an actress, a movie, a song, a cartoon, a hero, an idol, a politician, a city, a country, an animal, and/or any other topic of interest or combinations thereof. When featuring a theme, the book of this invention preferably incorporates pictures, text, and/or graphics associated with the theme. For example, if the theme of the book is a celebrity, pictures or photographs of the celebrity may be printed on the markable pages, pouch pages, display pages or the pillows. The book may also feature facts and/or stories about the celebrity printed on one or more of the pages and/or pillows. The book of this invention may also include a conventional-type book, such as a pocket book, about the celebrity. The book of this invention may further include a media storage device and/or information for obtaining such media, including songs, movies and/or pictures, featuring the celebrity.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A book comprising:
a first pillow having a first edge and a first periphery;
a second pillow having a second edge and a second periphery, the second edge of the second pillow hingedly connected to the first edge of the first pillow;
a fastener disposed between the first periphery and the second periphery;
a plurality of markable pages disposed between the first pillow and the second pillow, at least one of the markable pages constructed of washable material and washable to remove one or more color markings following coloration;
at least one pouch page disposed between the first pillow and the second pillow and defining an openably closeable storage pouch; and
at least one display page disposed between the first pillow and the second pillow and including a plurality of display pockets.

2. The book of claim 1, wherein the fastener is a zipper extending along and between the first periphery and the second periphery.

3. The book of claim 1, wherein at least one page of the plurality of markable pages forms a page pocket, the book further comprising a support sheet positioned within the page pocket.

4. The book of claim 3, wherein the support sheet is made of EVA foam.

5. The book of claim 1, wherein the plurality of markable pages are reattachably removable from the book.

6. The book of claim 1, wherein the book further comprises at least one page fastener.

7. The book of claim 6, wherein the plurality of markable pages are removably fastenable to the at least one page fastener.

8. The book of claim 1, further comprising an auditory transducer operably connectable to a player device.

9. The book of claim 8, wherein the auditory transducer is a speaker disposed within the first pillow.

10. The book of claim 1, further comprising at least one storage pocket formed with respect to the first pillow.

11. The book of claim 1, further comprising at least one storage pocket formed with respect to the second pillow.

12. The book of claim 2, wherein the fastener comprises:
at least one sliding element; and
a lock engageable with the at least one sliding element and the book to lock the book when in a closed position.

13. The book of claim 1, wherein the fastener comprises:
two sliding elements; and
a lock engageable with the two sliding elements to lock the book when in a closed position.

14. A book comprising:
a first pillow comprising a front sheet and an inner front sheet, the front sheet connected to the inner front sheet along a first periphery and a first edge of the first pillow;
a second pillow comprising a back sheet and an inner back sheet, the back sheet connected to the inner back sheet along a second periphery and a second edge of the second pillow, the second edge of the second pillow hingedly connected to the first edge of the first pillow;
a first filler positioned in a first cavity formed between the front sheet and the inner front sheet;
a second filler positioned in a second cavity formed between the back sheet and the inner back sheet;
a fastener disposed between the first periphery and the second periphery, the fastener comprising a zipper extending along and between the first periphery and the second periphery and including two sliding elements independently slidable along the zipper in a first direction to close the zipper and in a second direction to open the zipper;
a plurality of markable pages constructed of washable material, the plurality of markable pages disposed between the first pillow and the second pillow, each page of the plurality of markable pages is washable to remove one or more color markings following coloration;
at least one pouch page disposed between the first pillow and the second pillow and each defining an openably closeable storage pouch;
at least one display page disposed between the first pillow and the second pillow, each display page including a plurality of display pockets; and
at least one auditory transducer operably connectable to a player device.

15. The book of claim 14, further comprising:
a lock engageable with the two sliding elements to lock the two sliding elements together; and
a key engageable with the lock to release the lock and thus the two sliding elements.

16. The book of claim 14, wherein each of the plurality of display pockets is adapted to receive at least one object selected from the group consisting of a photograph, a postage stamp, a sticker, a postcard, a picture, and combinations thereof.

17. The book of claim 14, further comprising:
at least one storage pocket formed with respect to one of the first pillow and the second pillow; and
at least one secondary element selected from the group consisting of a marker, a book, a notebook, a notepad, a pen, a pencil, a crayon, a diary, and combinations thereof, the at least one secondary element positionable within the at least one storage pocket.

18. The book of claim 14, wherein the at least one pouch page is a resealable storage bag.

19. A book comprising:
a first pillow comprising a front sheet and an inner front sheet, the front sheet connected to the inner front sheet along a first periphery and a first edge of the first pillow;
a second pillow comprising a back sheet and an inner back sheet, the back sheet connected to the inner back sheet along a second periphery and a second edge of the second pillow, the second edge of the second pillow is hingedly connected to the first edge of the first pillow;
a first filler positioned in a first cavity formed between the front sheet and the inner front sheet;
a second filler positioned in a second cavity formed between the back sheet and the inner back sheet;
a fastener comprising a first fastener portion connected along the first periphery, a second fastener portion connected along the second periphery, and two sliding elements, each sliding element slidable along the first fastener portion and the second fastener portion in a first direction to engage the first fastener portion with the second fastener portion to close the book, each sliding element slidable along the first fastener portion and the second fastener portion in a second direction to disengage the first fastener portion from the second fastener portion to open the book;
a plurality of markable pages bound together along an inner edge of each markable page, the plurality of markable pages disposed between the first pillow and the second pillow, the plurality of markable pages constructed of fabric material and washable to remove one or more color markings therefrom following coloration;
at least one pouch page disposed between the first pillow and the second pillow and defining an openably closeable storage pouch;
at least one display page disposed between the first pillow and the second pillow and including a plurality of display pockets;
at least one divider page positioned between and separating the at least one pouch page, the at least one display page and the plurality of markable pages from each other;
at least one auditory transducer operably connectable to a player device;
a lock engageable with each of the two sliding elements to lock the two sliding elements together;
a key engageable with the lock to release the lock and thus the two sliding elements; and
at least one storage pocket formed with respect to at least one of the first pillow and the second pillow, the at least one storage pocket designed to accommodate at least one secondary element selected from the group consisting of a marker, a book, a notebook, a notepad, a pen, a pencil, a crayon, a diary, and combinations thereof.
